(19) United States
(12) Patent Application Publication
(10) Pub. No.: US 2016/0003250 A1
(43) Pub. Date: Jan. 7, 2016

(54) AXIAL SEAL FOR ROOTS-STYLE SUPERCHARGER

(71) Applicant: EATON CORPORATION, Cleveland, OH (US)

(72) Inventors: Paul J. MCWILLIAMS, Mendon, MI (US); Christopher Mark ZUZELSKI, Clarklake, MI (US)

(21) Appl. No.: 14/854,567

(22) Filed: Sep. 15, 2015

Related U.S. Application Data
(63) Continuation of application No. PCT/US2014/029148, filed on Mar. 14, 2014.
(60) Provisional application No. 61/792,540, filed on Mar. 15, 2013.

(51) Int. Cl. F04C 27/00; F02B 33/38; F04C 18/12

(52) U.S. Cl. CPC F04C 27/005; F04C 18/126; F02B 33/38; F04C 27/001

(57) ABSTRACT

A blower housing including a first and second rotor assembly such that the first rotor assembly includes a first rotor and a first shaft and the second rotor assembly includes a second rotor and a second shaft. The first and second rotors each have a plurality of lobes. Each first and second rotor includes an axial sealing extension that can be constructed to extend axially into the shaft opening. The axial sealing extension can include a radially outwardly facing sealing surface that opposes a radially inwardly facing sealing surface defined within the shaft opening. The radially outwardly facing sealing surface and the radially inwardly facing sealing surface can be configured to cooperate to form a radial sealing interface that extends around an axis. The radial sealing interface can include a radial seal clearance defined between the radially outwardly facing sealing surface and the radially inwardly facing sealing surface.

### CROSS REFERENCE TO RELATED APPLICATIONS

This application a Continuation of PCT/US2014/029148 filed on 14 Mar. 2014, which claims benefit of U.S. Provisional Application No. 61/792,540 filed on 15 Mar. 2013, and which application(s) are incorporated herein by reference. To the extent appropriate, a claim of priority is made to each of the above disclosed applications.

### TECHNICAL FIELD

The present disclosure relates to engine boosting systems, and, more particularly, to an axial rotor end seal for higher pressure applications.

### BACKGROUND

Superchargers and turbocharger are used to increase the amount of air supplied to an internal combustion engine. Both these systems increase the pressure of the intake air that enters the engine, thereby increasing the density of the intake air. Turbochargers are driven by the engine exhaust whereas superchargers are driven mechanically by the engine itself. There are a number of known advantages and disadvantages associated with both types of systems. For example, while turbochargers are recognized as being relatively more fuel efficient than superchargers, turbochargers typically have some delayed response commonly known as lag. Critical to supercharger function is sealing one transfer volume to the next. Traditionally, this has been accomplished by controlling the gap between the bearing plate and the rotor. However, a common leak path exists in the clearance area between the rotor shaft and the bearing plate.

Further development for an improved design that reduces this clearance area and the leak rate between transfer volumes is desired.

### SUMMARY

A blower including a blower housing that defines a blower chamber including first and second bore sections that extend respectively along first and second axes. The first and second bore sections can be defined by first and second bore-defining portions of the blower housing. The blower housing can also define an inlet and an outlet in fluid communication with the blower chamber. The blower housing further defining a timing gear chamber and the blower housing includes a divider wall that separates the blower chamber from the timing gear chamber. The divider wall can define first and second shaft openings respectively aligned along the first and second axes. The first and second shaft openings can extend through the divider wall from the blower chamber to the timing gear chamber. The blower housing further includes a first and second rotor assembly such that the first rotor assembly includes a first rotor and a first shaft and the second rotor assembly includes a second rotor and a second shaft. The first rotor can be configured to mount on the first shaft aligned along the first axis and the second rotor can be configured to mount on the second shaft aligned along the second axis. The first and second rotors each have a plurality of lobes between which pockets can be are defined. The lobes can be positioned within the blower chamber and be configured to convey fluid from the inlet to the outlet of the blower chamber. The lobes project outwardly from the first and second shafts and the lobes of the first rotor intermesh with the lobes of the second rotor. The divider wall supports first and second bearings that respectively rotationally support the first and second shafts within the first and second shaft openings. First and second timing gears can be positioned within the timing gear chamber such that the first and second timing gears intermesh with one another. The first shaft can extend through the first shaft opening and be coupled to the first timing gear and the second shaft can extend through the second shaft opening and be coupled to the second timing gear. The first rotor can include a first axial sealing extension that extends axially into the first shaft opening. The first axial sealing extension including a first radially outwardly facing sealing surface that opposes a first radially inwardly facing sealing surface defined within the first shaft opening. The first radially outwardly facing sealing surface and the first radially inwardly facing sealing surface can cooperate to form a first radial sealing interface that extends around the first axis. The second rotor can include a second axial sealing extension that extends axially into the second shaft opening. The second axial sealing extension including a second radially outwardly facing sealing surface that opposes a second radially inwardly facing sealing surface defined within the second shaft opening. The second radially outwardly facing sealing surface and the second radially inwardly facing sealing surface can cooperate to form a second radial sealing interface that extends around the second axis. The first and second shafts can have first and second shaft outer diameters at the first and second bearings and the first and second axial sealing extensions can have first and second extension outer diameters. The first and second extension outer diameters can be larger than the first and second shaft outer diameters. The lobes of the first and second rotors can define rotor tips such that a rotor tip clearance is defined between the rotor tips and the first and second bore-defining portions of the blower housing. The first radial sealing interface can include a first radial seal clearance defined between the first radially outwardly facing sealing surface and the first radially inwardly facing sealing surface. The second radial sealing interface includes a second radial seal clearance defined between the second radially outwardly facing sealing surface and the second radially inwardly facing sealing surface. The first and second radial seal clearances can each be less than or equal to 1.1 times the rotor tip clearance.

Another aspect of the present disclosure relates to an axial rotor seal arrangement for a roots-style supercharger. The axial rotor seal arrangement can be defined by rotors within a blower housing. The rotors can be mounted on shafts extending through shaft openings aligned along an axes. The rotors can include axial sealing extensions that extend axially into the shaft openings. The axial sealing extensions can include radially outwardly facing sealing surfaces that oppose radially inwardly facing sealing surfaces defined within the shaft openings. The radially outwardly facing sealing surfaces and the radially inwardly facing sealing surfaces can cooperate to form radial sealing interfaces that extend around the axes. The blower housing can define blower chambers that include bore sections extending along the axes. The bore sections can be defined by bore-defining portions of the blower housing. The rotors can have a plurality of lobes between which pockets can be defined. The lobes can be configured to convey fluid. The lobes of the rotors can define rotor tips. A rotor tip clearance can be defined between the rotor tips and the bore-defining portions of the blower housing. The radial sealing interfaces can each include a radial seal clearance defined between the radially outwardly facing sealing surfaces and the radially inwardly facing sealing surfaces. The radial seal clearances can be less than or equal to 1.1 times the rotor tip clearances.

A further aspect of the present disclosure relates to a method for reducing air leakage within a roots-type supercharger. The roots-type supercharger can include a rotor mounted on a shaft that defines an axes and the rotor having an axial sealing extension. The method can include positioning the axial sealing extension of the rotor within a shaft opening defined by a divider wall such that a sealing interface can be defined. The sealing interface can have a radial seal clearance less than or equal to 1.1 times a tip clearance of the rotor.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a perspective view of a Roots-type blower of the type which may utilize the present disclosure, showing both the inlet port and the outlet port;

FIG. 2 is a diagrammatic view, corresponding to a transverse cross-section through the blower, illustrating the overlapping rotor chambers and the rotor lobes;

FIG. 3 is a top view of the Roots-type blower of FIG. 1;

FIG. 4 is cross-sectional view taken along line 4-4 of FIG. 3;

FIG. 5 is an end view of the Roots-type blower of FIG. 1;

FIG. 6 is a cross-sectional view of the Roots-type blower taken along line 6-6 of FIG. 5;

FIG. 7 is an enlarged view of a portion of FIG. 4; and

FIG. 8 is an enlarged view of a portion of FIG. 7.

### DETAILED DESCRIPTION

Referring to the drawings wherein like reference numbers correspond to like or similar components throughout the several figures.

As used herein, a radial seal is a seal where the clearance between sealing surfaces of the seal is measured in a radial direction relative to an axis of rotation of the rotor.

As used herein, an axial seal is a seal where the clearance between sealing surfaces of the seal is measured in an axial direction relative to an axis of rotation of the rotor (i.e., the clearance is measured in an orientation parallel to the axis of rotation of the rotor).

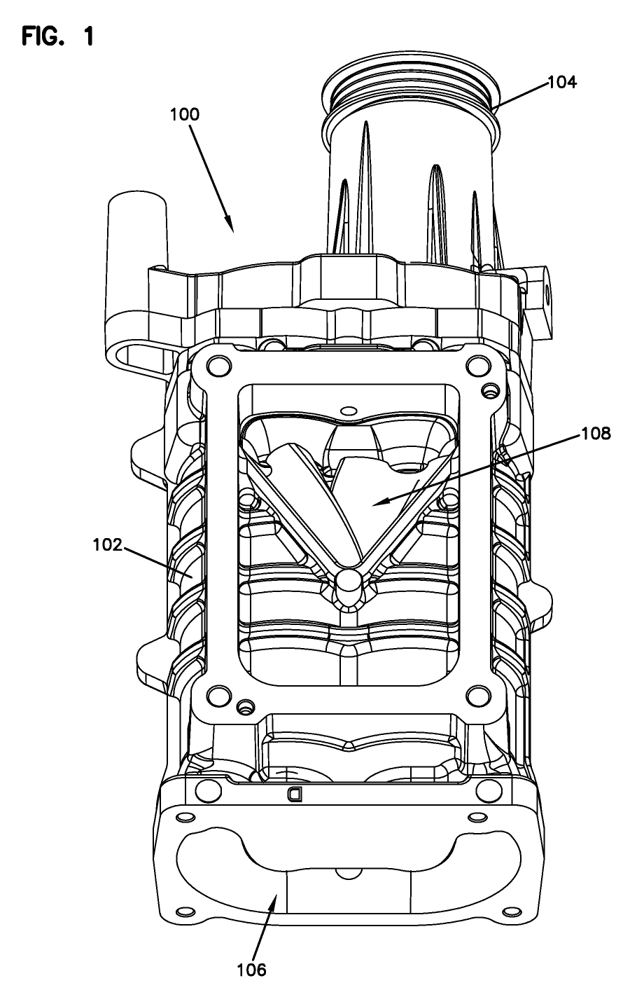

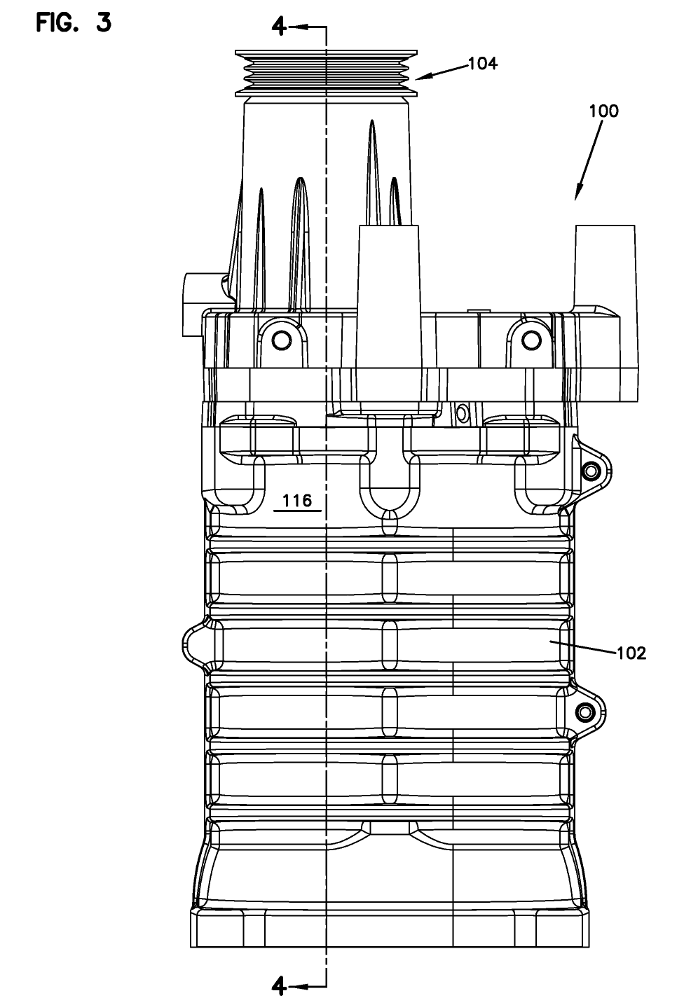

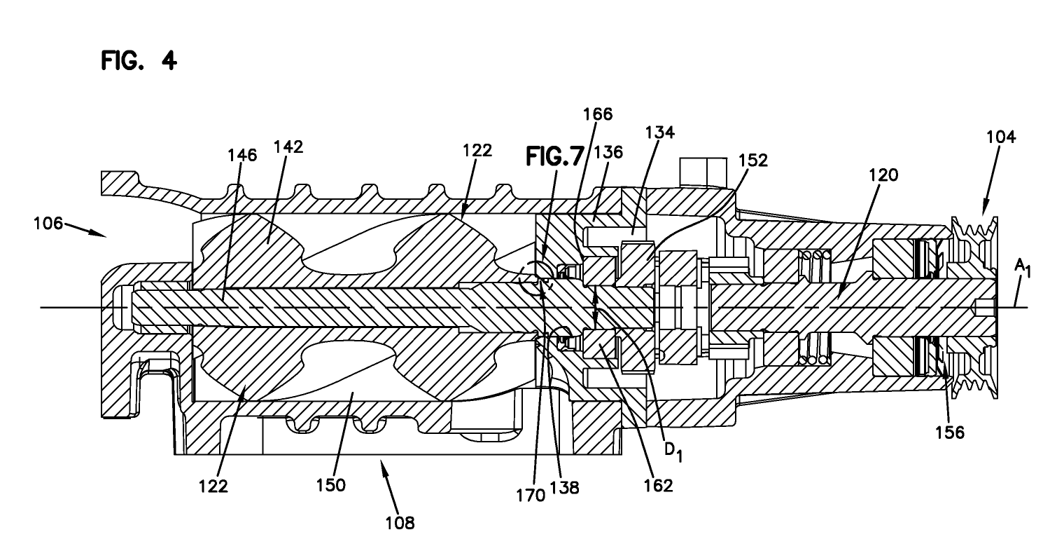

Referring to FIGS. 1-4, an external, perspective view of a Roots-type blower 100 is shown which includes a blower housing 102. The mechanical input to drive the blower rotors can be by means of a pulley 104. The blower housing 102 defines an inlet port 106 and an outlet port 108. The blower housing 102 defines an internal blower chamber 116 and an internal timing gear chamber 134 (i.e., a gear case cavity). An input drive shaft 120 (see FIG. 3) of the Roots-type blower 100 extends out of the gear case portion of the blower housing 102 and is driven via the pulley 104 by an output shaft of the engine (not shown). Within the blower chamber 116 is a first rotor 122 and a second rotor 124 such that when the first and second rotors 122, 124 are driven, both mesh and move air within the blower chamber 116 of the blower housing 102 from the inlet port 106 to the outlet port 108.

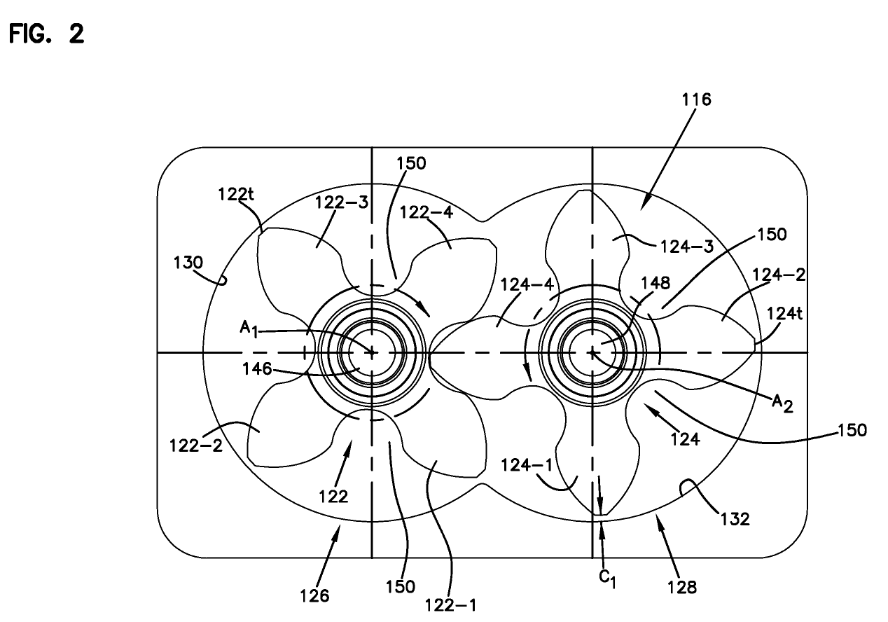

The blower chamber 116 includes a first bore section 126 and a second bore section 128 that can be generally cylindrically shaped. The first bore section 126 can extend along a first axes A₁ and the second bore section 128 can extend along a second axes A₂. As shown in FIG. 2, the first bore section 126 can be defined by a first bore-defining portion 130 and the second bore section 128 can be defined by a second bore-defining portion 132. The blower housing 102 can further define the timing gear chamber 134. A divider wall 136 (i.e., bearing plate) separates the blower chamber 116 from the timing gear chamber 134.

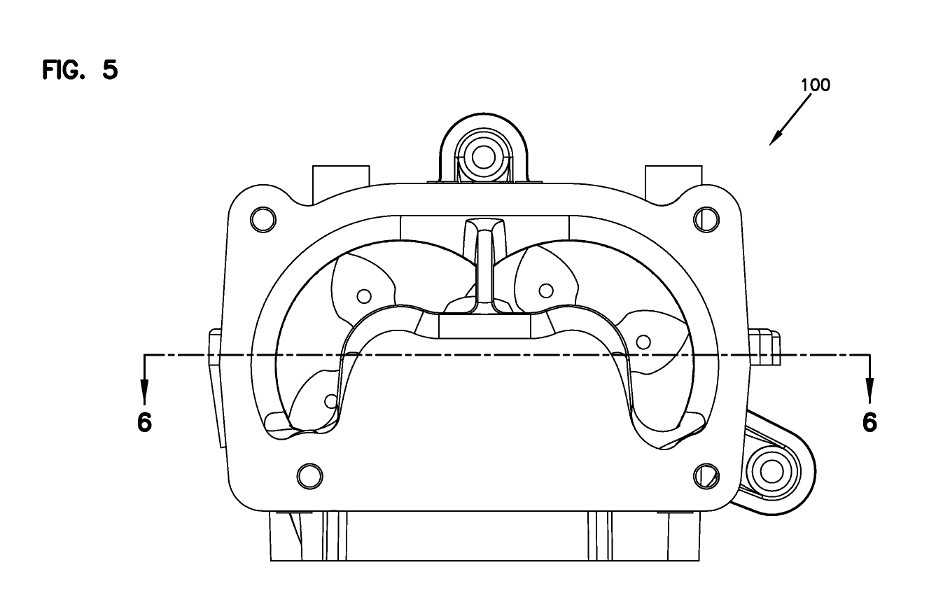

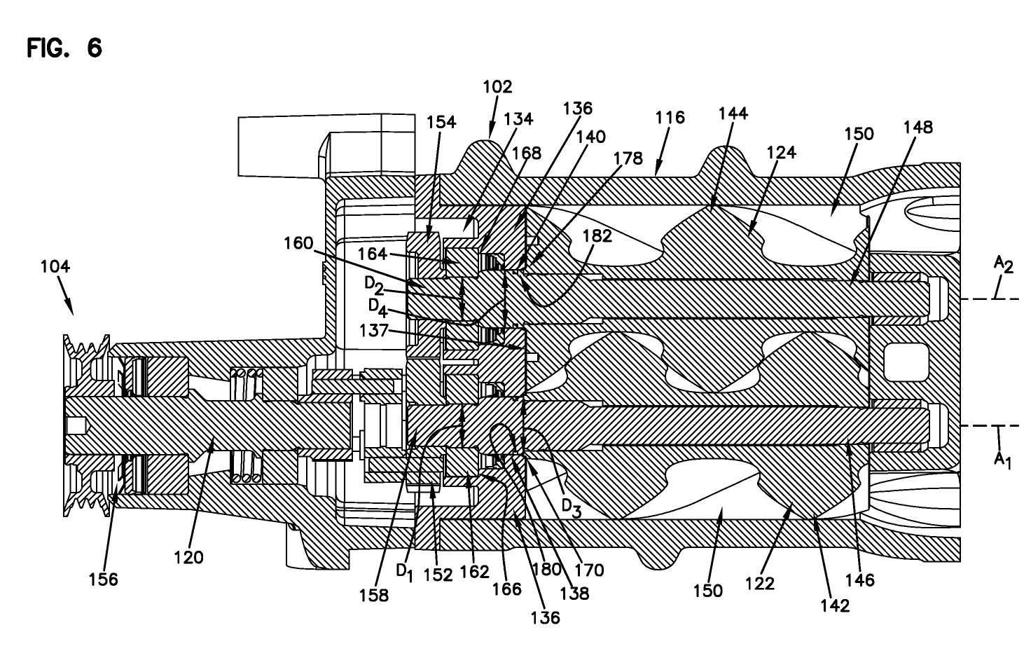

Referring to FIGS. 5-6, the divider wall 136 (i.e. bearing plate, see FIG. 6) can define a first shaft opening 138 and a second shaft opening 140 that are respectively aligned along the first and second axes A₁, A₂. As shown, the first and second axes A₁, A₂ are parallel and the first and second bore sections 126, 128 are respectively co-axial with the first and second axes A₁, A₂. The first and second shaft openings 138, 140 may extend through the divider wall 136 from the blower chamber 116 to the timing gear chamber 134. The blower housing 102 includes a first rotor assembly 142 and a second rotor assembly 144. The first rotor assembly 142 includes the first rotor 122 and a first shaft 146. The second rotor assembly 144 includes the second rotor 124 and a second shaft 148. The first and second shafts 146, 148 can be respectively co-axial with the first and second axes A₁, A₂. The first rotor 122 can be constructed to mount on the first shaft 146 and align along the first axis A₁ such that the first rotor 122 can be fixed relative to the first shaft 146. The second rotor 124 can be constructed to mount on the second shaft 148 and align along the second axis A₂ such that the second rotor 124 can be fixed relative to the second shaft 148. The first shaft 146 has a first shaft outer diameter D₁ at a first bearing 162 and the second shaft 148 has a second shaft outer diameter D₂ at a second bearing 164 which will be referenced further subsequently.

The first and second rotors 122, 124 may each define pockets 150 located between a plurality of lobes. The blower 100 may also include a first timing gear 152 and a second timing gear 154 positioned within the timing gear chamber 134 such that the first and second timing gears 152, 154 intermesh with one another. As shown in FIG. 6, the first shaft 146 can be constructed to extend through the first shaft opening 138 such that the first shaft 146 can be coupled to the first timing gear 152. The second shaft 148 can be constructed to extend through the second shaft opening 140 such that the second shaft 148 can be coupled to the second timing gear 154. In the depicted example, the second shaft 148 is generally parallel to the first shaft 146.

As additionally shown in FIG. 2, each rotor 122, 124 includes a plurality N of lobes. In one aspect of the present disclosure, and by way of example only, the plurality N is illustrated to be equal to 4, such that the first rotor 122 includes lobes, 122-1, 122-2, 122-3, and 122-4. In the same manner, the second rotor 124 includes four lobes, 124-1, 124-2, 124-3, and 124-4. As is well known to those skilled in the Roots-type blower art, when viewing the rotors from the inlet end as in FIG. 3, the left hand rotor 122 rotates clockwise, while the right hand rotor 124 rotates counterclockwise. Therefore, air which flows into the first and second bore-defining portions 130, 132 through the inlet port 106 will flow into, for example, a control volume defined between the lobes 122-1, 122-2, or between the lobes 124-1, 124-2, and the air contained in those control volumes will be carried by their respective lobes, and in their respective directions around the first and second bore-defining portions 130, 132, respectively, until those particular control volumes are in communication with the outlet port 108. Each of the lobes 122 may define a rotor tip 122t, and each of the lobes 124 may define a rotor tip 124t, the rotor tips 122t and 124t sealingly cooperating with the cylindrically first and second bore-defining portions 130, 132, respectively. A rotor tip clearance C₁ can be defined between the rotor tips 122t, 124t and the first and second bore-defining portions 130, 132 of the blower housing 102.

The plurality N of lobes (122-1 through 122-4, 124-1 through 124-4) can be positioned within the blower chamber 116 and be configured to convey fluid from the inlet port 106 to the outlet port 108 of the blower chamber 116. The plurality N of lobes (122-1 through 122-4, 124-1 through 124-4) may project respectively outwardly from the first and second shafts 146, 148 such that the lobes (122-1 through 122-4) of the first rotor 122 intermesh with the lobes (124-1 through 124-4) of the second rotor 124.

In the depicted example, the air pressure in the rotor cavity can be as high as 30-50 psi during normal operations. Left unmanaged, the air in the blower chamber 116 could escape past the divider wall 136 into the gear case portion 118, it can escape out of the gear case portion 118 via an annular sealing assembly 156 between the input drive shaft 120 and the gear case portion 118, and/or force lubrication fluid out of the annular sealing assembly 156.

Leakage of air and oil from the pulley end of the gear box is undesirable for a number of reasons including, for example, contamination of the engine compartment due to lubrication fluid leakage, failure of the components in the gear case portion due to lack of lubrication, decrease in possible boost pressure due to the leakage of air from the blower chamber 116, and degraded engine performance due to the discrepancy in the amount of metered air and actual air that is combusted by the engine. In one aspect, the air within the blower chamber 116 is managed to limit the amount of air leakage from the blower chamber 116 into the gear case portion. In another aspect, the first and second shafts 146, 148 each include driven end portions 158, 160 respectively. The driven end portions 158, 160 are supported by the first and second bearings 162, 164 that are pressed into the gear case side of the divider wall 136 against shoulders 166, 168. The first and second bearings 162, 164 are also configured to support the first and second shafts 146, 148 respectively within the first and second shaft openings 138, 140.

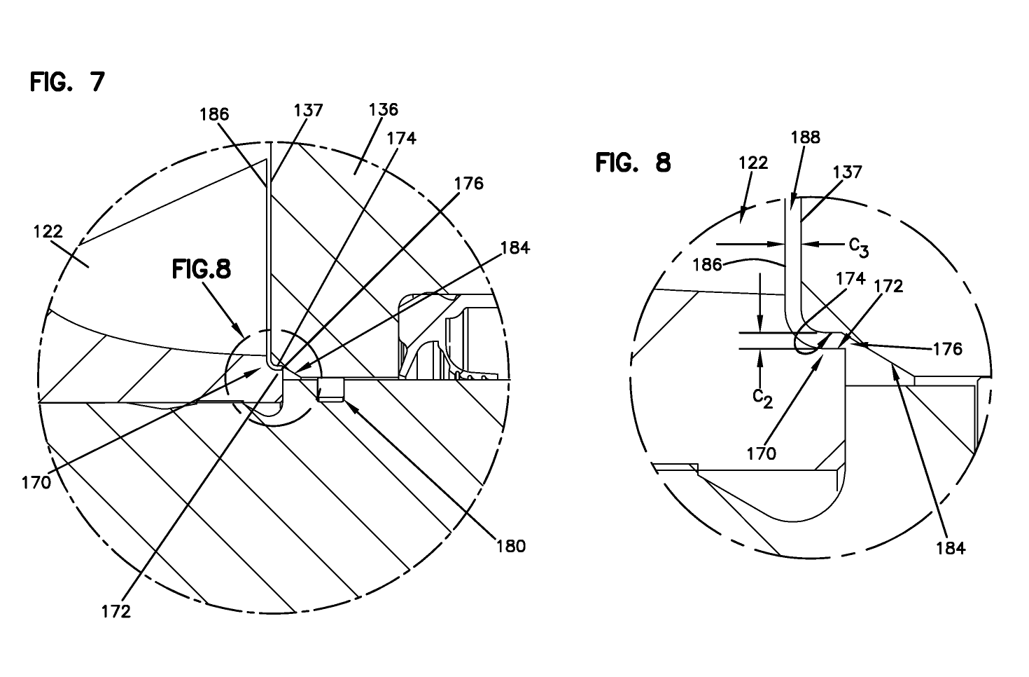

Referring to FIGS. 7-8, the first rotor 122 includes a first axial sealing extension 170 that can be constructed to extend axially into the first shaft opening 138. The first axial sealing extension 170 can include a first radially outwardly facing sealing surface 172 that opposes a first radially inwardly facing sealing surface 174 defined within the first shaft opening 138. The first radially outwardly facing sealing surface 172 and the first radially inwardly facing sealing surface 174 can be configured to cooperate to form a first radial sealing interface 176 that extends around the first axis A₁. The first radial sealing interface 176 can include a first radial seal clearance C₂ defined between the first radially outwardly facing sealing surface 172 and the first radially inwardly facing sealing surface 174. The second rotor 124 may also include a second axial sealing extension 178 that can be constructed to extend axially into the second shaft opening 140. The second axial sealing extension 178 has the same configuration as the first axial sealing extension 170 and forms a second radial sealing interface with the second shaft opening 140 in the same way the first axial sealing extension 170 forms a first radial sealing interface 176 with the first shaft opening 138. Thus, FIGS. 7 and 8 depicting the first sealing interface 176 are also representative of the second sealing interface and second radially inwardly and outwardly facing sealing surfaces corresponding to the second sealing interface.

The first and second axial sealing extensions 170, 178 can each have cylindrical portions having an axial length of at least 0.24 mm. In other examples, the first and second radial seal clearances can be uniform along an axial length of the first and second radial sealing interfaces. In the depicted example, the first radially outwardly facing sealing surface 172, the second radially outwardly facing sealing surface, the first radially inwardly facing sealing surface 174, and the second radially inwardly facing sealing surface can be, for example, machined surfaced. In another aspect of the present disclosure, the first radially outwardly facing sealing surface 172, the second radially outwardly facing sealing surface, the first radially inwardly facing sealing surface 174, and the second radially inwardly facing sealing surface can be abradable powder coated (APC). The machined surfaces may be coated with APC to further enhance its sealing capability. The first radially outwardly facing sealing surface 172, the second outwardly facing sealing surface, the first radially inwardly facing sealing surface 174 and the second inwardly facing sealing surface can be cylindrical in shape.

In this example, the first and second radial seal clearances C₂ can each be less than or equal to the rotor tip clearance C₁. For example, the first and second radial seal clearances C₂ can each be less than or equal to 1.1 times the rotor tip clearance C₁. In other examples, the first and second radial seal clearances C₂ can each be less than or equal to 1.05 times the rotor tip clearance C₁. Still in other examples, the first and second radial seal clearances C₂ can each be less than or equal to 1.025 times the rotor tip clearance C₁. In other examples, the first and second radial seal clearances C₂ can each be less than or equal to 1.01 times the rotor tip clearance C₁.

Referring again to FIG. 6, the first axial sealing extension 170 has a first extension outer diameter D₃. Similarly, the second axial sealing extension 178 has a second extension outer diameter D₄. As shown, the first and second extension outer diameters D₃, D₄ can be larger than the first and second shaft outer diameters D₁, D₂. The blower 100 can also include a first ring seal 180 positioned within the first shaft opening 138 axially between the first radial sealing interface 176 and the first bearing 162. The blower 100 can further include a second ring seal 182 positioned within the second shaft opening 140 axially between the second radial sealing interface and the second bearing 164.

Referring again to FIGS. 7-8, the first shaft opening 138 defines a first chamfer 184 positioned axially between the first radial sealing interface 176 and the first ring seal 180. Likewise, the second shaft opening 140 defines a second chamfer positioned axially between the second radial sealing interface and the second ring seal 182. In some examples, the first and second chamfers can be angled to reduce the first and second shaft opening diameters as the first and second chamfers extend axially away from the first and second radial sealing interfaces and axially toward the first and second ring seals 180, 182. In the depicted example, the pressure acting on the first and second ring seals 180, 182 can be managed both by the configuration of the first and second axial sealing extensions 170, 178. The extensions 170, 178 provide portions of the rotors 122, 124 that axially overlap portions of the divider wall 136 to minimize clearance and extend the sealing length to reduce air leakage between the blower chamber 116 and the timing gear chamber 134.

In other aspects, the divider wall 136 can include an axially facing surface 137 that defines an end of the blower chamber 116. Referring to FIGS. 7-8, the plurality of lobes 122-1 through 122-4 of the first rotor 122 can have an axially facing end face 186 that opposes the axially facing surface 137 of the divider wall 136 such that an axial sealing interface 188 can be defined between the axially facing end face 186 and the axially facing surface 137. As depicted, an axial seal clearance C₃ can be defined between the axially facing end face 186 and the axially facing surface 137 of the divider wall 136. The second rotor 124 can also have an axially facing end face that opposes the axially facing surface 137 of the divider wall 136 and has the same characteristics as the axially facing end face 186 described for the first rotor 122.

In the depicted example, the first and second radial seal clearances C₂ can each be less than or equal to the axial seal clearance C₃. In one example, the first and second radial seal clearances C₂ can be equal to one another. In the case where APC is used, the radial seal clearance C₂ can be less than 0.05 mm, or less than 0.025 mm, or as low as 0.00 mm. In some examples, the first and second radial seal clearances C₂ can each be less than or equal to 1.05 times the axial seal clearance C₃. In other examples, the first and second radial seal clearances C₂ can each be less than or equal to 1.025 times the axial seal clearance C₃. Still in other aspects, the first and second radial seal clearances C₂ can each be less than or equal to 1.01 times the axial seal clearance C₃.

Various modifications and alterations of this disclosure will become apparent to those skilled in the art without departing from the scope and spirit of this disclosure, and it should be understood that the scope of this disclosure is not to be unduly limited to the illustrative examples set forth herein.

1. A blower comprising:
a blower housing defining a blower chamber including first and second bore sections that extend respectively along first and second axes, the first and second bore sections being defined by first and second bore-defining portions of the blower housing, the blower housing also defining an inlet and an outlet in fluid communication with the blower chamber, the blower housing further defining a timing gear chamber, the blower housing including a divider wall that separates the blower chamber from the timing gear chamber, the divider wall defining first and second shaft openings respectively aligned along the first and second axes, the first and second shaft openings extending through the divider wall from the blower chamber to the timing gear chamber, the blower housing further including a first and second rotor assembly, wherein the first rotor assembly includes a first rotor and a first shaft and the second rotor assembly includes a second rotor and a second shaft;
the first rotor configured to be mounted on the first shaft aligned along the first axis, and the second rotor configured to be mounted on the second shaft aligned along the second axis, the first and second rotors each having a plurality of lobes between which pockets are defined, the lobes being positioned within the blower chamber and being configured to convey fluid from the inlet to the outlet of the blower chamber, the lobes projecting outwardly from the first and second shafts, and the lobes of the first rotor intermeshing with the lobes of the second rotor, and wherein the divider wall supports first and second bearings that respectively rotationally support the first and second shafts within the first and second shaft openings;
first and second timing gears positioned within the timing gear chamber, the first and second timing gears intermeshing with one another;
the first shaft extending through the first shaft opening and being coupled to the first timing gear;
the second shaft extending through the second shaft opening and being coupled to the second timing gear;
the first rotor including a first axial sealing extension that extends axially into the first shaft opening, the first axial sealing extension including a first radially outwardly facing sealing surface that opposes a first radially inwardly facing sealing surface defined within the first shaft opening, the first radially outwardly facing sealing surface and the first radially inwardly facing sealing surface cooperating to form a first radial sealing interface that extends around the first axis;
the second rotor including a second axial sealing extension that extends axially into the second shaft opening, the second axial sealing extension including a second radially outwardly facing sealing surface that opposes a second radially inwardly facing sealing surface defined within the second shaft opening, the second radially outwardly facing sealing surface and the second radially inwardly facing sealing surface cooperating to form a second radial sealing interface that extends around the second axis;
the first and second shafts having first and second shaft outer diameters at the first and second bearings, the first and second axial sealing extensions having first and second extension outer diameters, and the first and second extension outer diameters being larger that the first and second shaft outer diameters;
the lobes of the first and second rotors defining rotor tips, wherein a rotor tip clearance is defined between the rotor tips and the first and second bore-defining portions of the blower housing;
wherein the first radial sealing interface includes a first radial seal clearance defined between the first radially outwardly facing sealing surface and the first radially inwardly facing sealing surface, and wherein the second radial sealing interface includes a second radial seal clearance defined between the second radially outwardly facing sealing surface and the second radially inwardly facing sealing surface; and
the first and second radial seal clearances each being less than or equal to 1.1 times the rotor tip clearance.

2. The blower of claim 1, wherein the first and second radial seal clearances are each less than or equal to 1.05 times the rotor tip clearance.

3. The blower of claim 1, wherein the first and second radial seal clearances are each less than or equal to 1.025 times the rotor tip clearance.

4. The blower of claim 1, wherein the first and second radial seal clearances are each less than or equal to 1.01 times the rotor tip clearance.

5. The blower of claim 1, wherein the first and second radial seal clearances are each less than or equal to the rotor tip clearance.

6. The blower of claim 5, further comprising a first ring seal positioned within the first shaft opening axially between the first radial sealing interface and the first bearing and a second ring seal positioned within the second shaft opening axially between the second radial sealing interface and the second bearing.

7. The blower of claim 6, wherein the first shaft opening includes a first chamfer positioned axially between the first radial sealing interface and the first ring seal, wherein the second shaft opening defines a second chamfer positioned axially between the second radial sealing interface and the second ring seal, wherein the shaft openings have first and second shaft opening diameters, and wherein the first and second chamfers are angled to reduce the first and second shaft opening diameters as the first and second chamfers extend axially away from the first and second radial sealing interfaces and axially toward the first and second ring seals.

8. The blower of claim 7, wherein the divider wall includes an axially facing surface that defines an end of the blower chamber, wherein the lobes of the first and second rotors have axially facing end faces that oppose the axially facing surface of the divider wall such that axial sealing interfaces are defined between the axially facing end faces and the axially facing surface, and wherein an axial seal clearance is defined between the axially facing end faces and the axially facing surface of the divider wall.

9. The blower of claim 8, wherein the first and second radial seal clearances are each less than or equal to 1.05 times the axial seal clearance.

10. The blower of claim 8, wherein the first and second radial seal clearances are each less than or equal to 1.025 times the axial seal clearance.

11. The blower of claim 8, wherein the first and second radial seal clearances are each less than or equal to 1.01 times the axial seal clearance.

12. The blower of claim 8, wherein the first and second radial seal clearances are each less than or equal to the axial seal clearance.

13. The blower of claim 1, wherein the first and second radial seal clearances are equal to one another.

14. The blower of claim 1, wherein the first outwardly facing sealing surface, the second outwardly facing sealing surface, the first inwardly facing sealing surface and the second inwardly facing sealing surface are machined surfaces.

15. The blower of claim 1, wherein the first outwardly facing sealing surface, the second outwardly facing sealing surface, the first inwardly facing sealing surface and the second inwardly facing sealing surface are abradable powder coated.

16. The blower of claim 1, wherein the axial sealing extensions each have cylindrical portions having an axial length of at least 0.24 mm.

17. The blower of claim 1, wherein the first and second axes are parallel, wherein the first and second bore sections are cylindrical, wherein the first and second bore sections are respectively co-axial with the first and second axes, wherein the first and second shafts are respectively co-axial with the first and second axes and wherein the first and second shaft are respectively co-axial with the first and second axes.

18. The blower of claim 1, wherein the first outwardly facing sealing surface, the second outwardly facing sealing surface, the first inwardly facing sealing surface and the second inwardly facing sealing surface are cylindrical, and wherein the first and second radial seal clearances are uniform along axial length of the first and second radial sealing interfaces.

19. An axial rotor seal arrangement for a roots-style supercharger, the axial rotor seal arrangement being defined by rotors within a blower housing, the rotors being mounted on shafts extending through shaft openings aligned along an axes, the rotors including axial sealing extensions that extend axially into the shaft openings, the axial sealing extensions including radially outwardly facing sealing surfaces that oppose radially inwardly facing sealing surfaces defined within the shaft openings, the radially outwardly facing sealing surfaces and the radially inwardly facing sealing surfaces cooperating to form radial sealing interfaces that extend around the axes;
the blower housing defining blower chambers including bore sections extending along the axes, the bore sections being defined by bore-defining portions of the blower housing;
the rotors having a plurality of lobes between which pockets are defined, the lobes being configured to convey fluid, the lobes of the rotors defining rotor tips, wherein a rotor tip clearance is defined between the rotor tips and the bore-defining portions of the blower housing;
wherein the radial sealing interfaces each include a radial seal clearance defined between the radially outwardly facing sealing surfaces and the radially inwardly facing sealing surfaces; and
the radial seal clearances being less than or equal to 1.1 times the rotor tip clearances.

20.-29. (canceled)

30. A method for reducing air leakage within a roots-type supercharger, the roots-type supercharger including a rotor mounted on a shaft that defines an axes, the rotor having an axial sealing extension, the method comprising:
positioning the axial sealing extension of the rotor within a shaft opening defined by a divider wall such that a sealing interface is defined, the sealing interface having a radial seal clearance less than or equal to 1.1 times a tip clearance of the rotor.

31.-38. (canceled)
